(19) United States
(12) Patent Application Publication
(10) Pub. No.: US 2009/0297407 A1
(43) Pub. Date: Dec. 3, 2009

(54) STRUCTURE AND CATALYTIC FILTER FOR FILTERING A GAS COMPRISING A HYDROPHOBIC OR OLEOPHOBIC CEMENT

(75) Inventors: Partricia Andy, Les Taillades (FR); Anthony Briot, Avignon (FR); Sebastien Bardon, Paris (FR); Caroline Tardivat, Aix-en-Provence (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN CENTRE DE RECHERCHES ET D'ETUDES EUROPEEN, COURBEVOIE (FR)

(21) Appl. No.: 11/917,463

(22) PCT Filed: Jun. 13, 2006
(86) PCT No.: PCT/FR06/50554

§ 371 Date: Aug. 4, 2008

(30) Foreign Application Priority Data
Jun. 14, 2005 (FR) 0551595

(51) Int. Cl. B01J 35/04; B01J 37/02; B01D 53/94

(52) U.S. Cl. 422/180; 428/116; 156/197

(57) ABSTRACT

The invention relates to an assembled structure that can be used, after deposition of a catalyst, for filtering a gas loaded with soot particles and pollutants in the gas phase in which the cement used as a coating cement and/or as a joint cement comprises, at least at the surface, a hydrophobic or oleophobic material.

The invention also relates to the assembled catalytic filter obtained after impregnating with a catalytic solution of said structure and also to the process for manufacturing the filter from said structure.

The invention relates to the field of particle filters especially used in an exhaust line of an engine for removing the soot produced by combustion of a diesel fuel in an internal combustion engine. More precisely, the invention relates to a filter structure and to a particle filter, said filter comprising a material giving it catalytic properties, and also to the process for preparing it.

The filtration structures for the soot contained in internal combustion engine exhaust gases are well known in the prior art. These structures usually have a honeycomb structure, one of the faces of the structure allowing the intake of the exhaust gases to be filtered and the other face the discharge of the filtered exhaust gases. The structure comprises, between the intake and discharge faces, a set of adjacent ducts or channels with axes parallel with one another separated by porous filtration walls, which ducts are stopped at one or other of their ends to delimit inlet chambers opening on the intake face and outlet chambers opening on the discharge face. For a good seal, the peripheral part of the structure is surrounded by a cement, referred to as a coating cement in the remainder of the description. The channels are alternately stopped in an order such that the exhaust gases, as they pass through the honeycomb body, are forced to pass through the side walls of the inlet channels in order to join the outlet channels. In this way, the particles or soot are deposited and accumulate on the porous walls of the filtering body. Usually, the filtering bodies are made of a porous ceramic material, for example corderite or silicon carbide.

In a known manner, during its use, the particle filter is subjected to a succession of filtration phases (accumulation of soot) and regeneration phases (removal of soot). During the filtration phases, the soot particles emitted by the engine are retained and deposited inside the filter. During the regeneration phases, the soot particles are burnt inside the filter, in order to restore its filtration properties thereto. The porous structure is then subjected to intense thermal and mechanical stresses, which may cause micro-cracks that are likely over time to cause a severe loss of the filtration abilities of the unit, or even its complete deactivation. This phenomenon is particularly observed on large-diameter monolithic filters.

To solve these problems and increase the service life of the filters, more complex filtration structures have more recently been proposed that combine several honeycomb monolithic elements in a filtering block. The elements, after plugging to delimit the inlet chambers and the outlet chambers of the gas, are usually assembled together by bonding using a cement of ceramic nature, referred to in the remainder of the description as a joint cement or joint. Examples of such filtering structures are, for example, described in Patent Applications EP 816 065, EP 1 142 619, EP 1 455 923 or else WO 2004/090294.

It is known that in this type of structure, in order to ensure a better relaxation of the stresses, the thermal expansion coefficients of the various parts of the structure (that is to say the filtering elements, the coating cement, the joint cement and the cement forming the plugs) must be approximately of the same order. Therefore, said parts are synthesized based on one and the same material, usually silicon carbide SiC or corderite. This choice makes it possible, moreover, to homogenize the heat distribution during regeneration of the filter. The expression “based on one and the same material” is understood in the sense of the present description to mean that the material is composed of at least 25 wt %, preferably of at least 45 wt % and more preferably of at least 70 wt % of said material.

The soot filters or porous filtration structures as described previously are mainly used on a large scale in pollution control devices for the exhaust gases of a diesel engine.

In addition to the problem of treating soot, the conversion of gas-phase polluting emissions (that is to say mainly nitrogen oxides (NOₓ) or sulfur oxides (SOₓ) and carbon monoxide (CO), or even unburnt hydrocarbons) into less harmful gases (such as gaseous nitrogen (N₂) or carbon dioxide (CO₂)) requires an additional catalytic treatment.

According to a first technology, to remove all of the pollutants, the exhaust line of the internal combustion engine comprises, in series, a catalytic purification member and a particle filter.

The catalytic purification member, generally having an open honeycomb structure, is suitable for treating gas-phase pollutants, whereas the particle filter is suitable for removing the soot particles emitted by the engine. Besides the complexity of implementing this solution and its cost, the succession of filtering elements in the exhaust line is however responsible for a not insignificant pressure drop in said line, capable of influencing the engine performance.

To solve these problems, it has been sought to transfer the catalytic function to a monolithic-type particle filter. According to conventionally used processes, the honeycomb structure is impregnated with a solution comprising the catalyst or a catalyst precursor.

Such processes generally comprise an impregnation step via immersion either in a solution containing a catalyst precursor or the catalyst dissolved in water (or another polar solvent), or a suspension of catalyst particles in water. One example of such a process is described by U.S. Pat. No. 5,866,210. According to this process, the application of an underpressure to the other end of the filter subsequently enables the rise of the solution in the structure and consequently the coating of the inner walls of the honeycomb structure. Alternatively, but less frequently, the impregnation step may be carried out by using a solution containing a non-polar solvent such as an oil or a hydrocarbon or surfactants.

According to other embodiments of the process for impregnating honeycomb filters, said impregnations may be obtained by pumping, by application of a vacuum or under the pressure of the liquid comprising the impregnation solution, over at least one end of the monolith. Usually, the processes described are characterized by a combination of these various techniques, during successive steps, the final step allowing the removal of the solution in excess in the filter by introduction of pressurized air or by suction. One of the main objectives sought by the implementation of these processes is the production of a uniform coating of the catalyst on, or even inside, at least one part of the porous walls of the channels that make up the inner part of the structure and through which the exhaust gases pass.

Such processes, and also the devices for their implementation, are, for example, described in Patent Applications or Patents US 2003/044520, WO 2004/091786, U.S. Pat. No. 6,149,973, U.S. Pat. No. 6,627,257, U.S. Pat. No. 6,478,874, U.S. Pat. No. 5,866,210, U.S. Pat. No. 4,609,563, U.S. Pat. No. 4,550,034, U.S. Pat. No. 6,599,570, U.S. Pat. No. 4,208,454 or else U.S. Pat. No. 5,422,138.

Whichever method is used, the cost of the catalysts deposited, which usually contain precious metals from the platinum group (Pt, Pd, Rh), on an oxide support represents a not insignificant part of the overall cost of the impregnation process. It is therefore important not only that the catalyst be deposited uniformly on the walls of the filtration channels, but also that a minimal part of it is deposited on the parts of the honeycomb structure which are not involved in filtering the gases or soots. Said parts are mainly the coating cement for a monolithic structure, with the addition of the joint cement and plugs, in the case of a filtering block such as described previously, that is to say a block combining several honeycomb monolithic elements.

Known from Patent Application JP 56/133036 is a method for depositing a catalyst on a honeycomb ceramic structure that aims to deposit mainly rare-earth metals in the walls of the filtration channels. It consists, on a monolithic ceramic structure, in coating the coating cement, before deposition of the catalyst, with a hydrophobic agent from the family of fluoro or silicone compounds, the front and rear faces of the monolithic structure having been previously masked with an adhesive.

This method cannot however be used effectively for minimizing the part of the catalyst that is found on the joint cement and the plugs of the elements of a filter assembled according to the invention. By way of example, in such a structure, the joint cement surface area may represent more than 10% of the surface area of the inlet (and outlet) section of the filter. Still by way of example and in such a structure, the combined surface area of the joints and the plugs may represent more than 30% of the surface area of the inlet section of the filter.

Moreover, unlike the monolithic structure described in JP 56/133036, the assembly process usually leads to a relative irregularity of the filter according to the invention at its front and rear faces. This lack of flatness of the faces results from a lack of alignment of the elements, following possible sliding of the elements with respect to one another, both in a longitudinal and transverse direction, before setting of the joint cement. For this reason, the masking itself of the elements becomes inaccurate, difficult to achieve in a reproducible manner over an entire population of filters and may result in undesired deposits of hydrophobic-based solution at the top of the intake or discharge channels and may then disrupt the homogeneous deposition of catalyst on the filtering parts.

The object of the present invention is therefore to limit, during a process for impregnating a particle filter having a structure assembled from honeycomb elements, the amount of catalyst present on the parts of the structure which do not have the role of filtering the gas to be filtered or the soot.

More precisely, the present invention relates, according to a first aspect, to a structure that can be used, after deposition of a catalyst, for filtering a gas loaded with soot particles and pollutants in the gas phase, said structure comprising:

a central part comprising a plurality of filtering elements as a honeycomb connected together by a joint cement, said element or elements comprising a set of adjacent ducts or channels with axes parallel with one another separated by porous walls, which ducts are stopped by plugs at one or other of their ends to delimit inlet chambers opening on a gas intake face and outlet chambers opening on a gas discharge face, in such a way that the gas to be filtered passes through the porous walls; and

a peripheral part made up of a coating cement protecting said elements,

said structure being characterized in that the coating cement, preferably the joint cement and optionally the cement forming the plugs, comprise a hydrophobic and/or oleophobic material.

The expression “hydrophobic material” is understood in the sense of the present description to mean any material that makes it possible to reduce the amount of a polar liquid, such as water, adsorbed at the surface or in the porosity of the cement used, when the structure is immersed in said polar liquid.

The expression “oleophobic material” is understood in the sense of the present description to mean any material that makes it possible to reduce the amount of a non-polar liquid, such as an oil, adsorbed at the surface or in the porosity of the cement used, when the structure is immersed in said non-polar liquid.

Preferably, said structure is composed of a filtering block combining several honeycomb monolithic filtering elements, said elements being bonded by a joint cement comprising a hydrophobic or oleophobic material.

Typically, said element or elements, the coating cement and optionally the joint cement and/or the cement forming the plugs are based on one and the same ceramic material, preferably based on silicon carbide SiC.

Any material known for its hydrophobic or oleophobic action at the surface or in the porosity of a cement may be used according to the invention. Examples of such compounds are well known in the prior art. Examples will be given in the remainder of the description.

The invention also relates to a process for obtaining a filter for filtering a gas loaded with soot particles and pollutants in the gas phase such as carbon monoxide CO, nitrogen oxides NOₓ, sulfur oxides SOₓ, hydrocarbons HC, said process comprising the steps of:
manufacturing a first structure such as described previously, in which the coating cement and preferably the joint cement and optionally the cement forming the plugs comprise a hydrophobic material; and
impregnating said structure with a solution containing a catalyst precursor or the catalyst dissolved in a polar solvent such as water, or a suspension of catalyst particles in a polar solvent such as water.

As will be shown subsequently in the examples provided, such a process makes it possible to minimize the amount of precious metal used during the step of impregnating the structure.

A first class of hydrophobic materials that can be used according to the invention is in powder form, for example carbon graphite, CaF₂, or other hydrophobic mineral powders containing the element fluorine. The hydrophobic material preferably has a suitable particle size, for example in the form of a powder of which 90% by combined weight of the grains have a diameter less than 500 microns and preferably 90% by weight of the grains have a diameter less than 200 microns. So as to optimize the rheology and compaction of the cement, if necessary and according to techniques known in the art, the ceramist will adapt, according to the invention, the particle size spectrum of SiC to the incorporation of the hydrophobic material or will carry out suitable additions, especially of plasticizer.

Another class of hydrophobic materials that can be used according to the invention are organic or organometallic compounds chosen from those known for their water-repellant action in the field of cement materials for the construction industry, for example of the type described in the reference work “Lea's Chemistry of Cement and Concrete, 4th Ed, P. C. Hewlett, 1988, p. 883-887”.

Such compounds are, for example, the metal salts of C₁₂-C₂₀ fatty acids such as alkali metal or alkaline-earth metal stearates or oleates, silicones, silanes, siloxanes, siliconates, organofluoro compounds having a low surface tension including PTFE powders, acrylic and vinyl resins, or paraffin oils.

According to the invention, several methods for incorporating the material, depending on its nature, are possible: the material may be either incorporated into the formulation of the coating and/or joint cement and/or of the cement forming the plugs before the steps of coating and assembling the structure such as is described in example 2, or deposited by liquid or gaseous route after said steps of coating/assembling the structure as described in example 3.

The method according to the invention in which the hydrophobe or oleophobe is incorporated into the cement formulation (and is therefore in the end present in the mass of said cement and/or forms part of this) has the advantage of not requiring an additional step with respect to the process for manufacturing the filter that incorporates a process for depositing the hydrophobe or the oleophobe by gaseous or liquid route, in particular, the masking step that makes it possible to selectively deposit this in the porosity of the coating and/or joint and/or plug cement is not necessary.

The incorporation method can usually only be carried out in limited proportions of hydrophobe or of oleophobe, typically between 0.1 and 10%, preferably between 0.5 and 6%, by weight relative to the dry weight of the cement, depending on the nature of the addition, the particle size of the graphite powder for example, or the hydrophobicity, especially the wetting angle with water. Below 0.1%, it has been observed that the hydrophobic effect is insufficient. Above 10%, the addition of water required for use of the cement is too high, which leads to problems of cracking during drying of the cement and then to problems of mechanical cohesion of the assembled filter. Above 10%, problems may also be faced of dispersion of the addition incorporated, bringing back into question the homogeneity of the cement and of the desired effect. Setting or curing problems may also be faced for additions that are too high, or even problems of foaming, which cannot be solved with anti-foaming agents.

According to the method in which the hydrophobe or oleophobe is deposited by a gaseous route, it is possible, for example and as described in example 3, to vaporize it at low temperature then to redeposit it at the surface of the cement, advantageously only on the unmasked parts of the filter.

According to one variant of the process for obtaining the filter, this comprises the steps of:
manufacturing a first structure such as described previously, in which the coating cement and preferably the joint cement and optionally the cement forming the plugs comprise an oleophobic material; and
impregnating said structure with a solution containing a catalyst precursor or the catalyst dissolved in a hydrophobic solvent such as a hydrocarbon or an oil, or a suspension of catalyst particles in a solution containing a non-polar solvent such as an oil or a hydrocarbon or surfactants.

In the same way as before, such a process makes it possible to minimize the amount of catalyst used during the step of impregnating the structure.

The oleophobic material is, for example, included in the group composed of silanes, siloxanes, siliconates and organofluoro compounds having a low surface tension. The oleophobic material is, for example, a fluoropolymer or a silane derivative, or a silane/fluorosilane mixture such as Z-6707 Silane® from Dow Corning, or else a fluoropolymer such as Zonyl MP 1400® from Du Pont Germany, in the form of a powder having a median particle diameter of around 12 μm. Generally, the products that are suitable are those having a critical surface tension below the surface tension of the solution in which the catalyst is dissolved.

The incorporation of the oleophobic material may be carried out according to the same principles and techniques as described previously for the incorporation of the hydrophobic material.

According to the invention, said impregnation of the structure with the polar or non-polar liquid containing the catalyst or a catalyst precursor may be carried out by any method known in the art and especially by pumping the solution through the structure, by application of a vacuum or an underpressure or under the pressure of the liquid comprising the impregnation solution over at least one end of the structure. A better impregnation is generally obtained by a combination of these various techniques, during successive steps, usually a final step allowing the removal of the solution in excess in the filter by suction or by introduction of pressurized air.

According to the invention, the impregnation step may be carried out according to the processes and/or devices known in the prior art and especially according to one of the processes or devices described in the aforementioned patents or patent applications.

The invention relates, according to a third aspect, to the catalytic filter obtained by the manufacturing process such as has just been described and which is characterized by the presence of a hydrophobic or oleophobic material at the surface and preferably in the porosity of the coating and/or joint cement, and also by the presence of a minimal amount of catalyst on said cement. The expression “minimal amount” is understood in the sense of the present description to mean a lower amount of catalyst relative to the amount of catalyst present within the filtering walls of the filter, that is to say within the honeycomb monolithic elements.

The invention and its advantages will be better understood on reading the examples which follow. It is clearly understood that these examples should not be considered, in any of the aspects described, as limiting the present invention.

### EXAMPLE 1

A filtering structure comprising a set of silicon carbide filtering elements connected by a joint cement was synthesized according to the techniques described in Patent EP 1 142 619.

Sixteen monolithic filtering elements having a square cross section were first extruded, dried then cured according to well-known techniques, for example described in EP 1 142 619.

A cement for the joint and the coating was then prepared by mixing:
85 wt % of an SiC powder having a particle size between 10 and 200 μm;
4 wt % of a calcined alumina powder sold by Almatis;
10 wt % of a reactive alumina powder sold by Almatis;
0.9 wt % of a temporary binder and of a plasticizer of the cellulose type; and
0.1 wt % of a deflocculant of the NaTPP (sodium tripolyphosphate) type.

An amount of water corresponding to 10% of the weight of this mixture was added to obtain a cement of suitable viscosity.

After assembling the monoliths by means of said cement then machining the outer surface of the structure thus obtained, said outer surface was then covered with the same cement for its coating. The assembly was re-cured at a sufficient temperature to ensure a satisfactory cohesion of the filter and its elements.

The characteristics of the crude filtration structure thus synthesized are given in table 1.

TABLE 1
characteristics of the crude structure (before impregnation)

| Channel geometry | Square |
|---|---|
| Channel density | 180 cpsi (channels per |
| | square inch, |
| | 1 inch = 2.54 cm) |
| Wall thickness | 350 μm |
| Number of elements assembled | 16 |
| Shape of the structure | Cylindrical |
| Length | 6″ (15.2 cm) |
| Volume | 2.48 liters |
| Weight % of the elements and plugs | 80% |
| Weight % of the joint cement | 13% |
| Weight % of the coating cement | 7% |

This crude structure was then submerged in a bath of an aqueous solution containing the appropriate amounts of a platinum precursor in the form of H₂PtCl₆, and of a cerium oxide CeO₂ precursor (in the form of cerium nitrate) and of a zirconium oxide ZrO₂ precursor (in the form of zirconyl nitrate) according to the principles described in the publication EP 1 338 322 A1. The filter was impregnated by the solution according to an implementation method similar to that described in U.S. Pat. No. 5,866,210. The filter was then dried at around 150° C., then heated to a temperature of around 600° C.

Chemical analysis showed a total Pt concentration of 52 g/ft³ (1 g/ft³=0.035 kg/m³), namely 4.5 g distributed nonhomogeneously over the various parts of the filter.

More precisely, the analysis revealed the following distribution:
0.25 wt % of platinum in the honeycomb elements, namely 4.0 g;
0.13 wt % of platinum in the coating cement, namely 0.25 g, over a thickness of a few tens of μm starting from the outer surface of the cement; and
0.08 wt % of platinum in the joint cement, namely 0.25 g, the platinum being distributed homogeneously over the entire thickness of the cement.

### EXAMPLE 2

A catalytic filter was manufactured by repeating the same steps as those from example 1, with the difference that this time the cement formulation was modified as follows by incorporating a hydrophobic graphite powder:
80 wt % of an SiC powder having a particle size between 10 and 200 μm;
3.5 wt % of a calcined alumina powder sold by Almatis;
9 wt % of a reactive alumina powder sold by Almatis;
5.4 wt % graphite of Timrex® KS75 type from Timcal (99.9% synthetic powder, having a density of 2.24 and a BET surface area of 6.5 m²/g), of which 90 wt % of the particles have a diameter less than 60 microns;
2 wt % of a temporary binder and of a plasticizer of cellulose type; and
0.1 wt % of a deflocculant of NaTPP (sodium tripolyphosphate) type.

An amount of water corresponding to around 15% of the weight of this mixture was added in order to obtain a cement of suitable viscosity. After assembling the monoliths by means of said cement then machining the outer surface of the structure thus obtained, said outer surface was then covered with the same cement for its coating. The assembly was re-cured at a sufficient temperature to ensure a satisfactory cohesion of the filter.

The characteristics of the crude structure and of the filter obtained after impregnation according to this example were approximately the same as those obtained for example 1 and listed in table 1.

The chemical analysis showed a total Pt concentration of 49 g/ft³, namely 4.3 g distributed over the various parts of the filter.

More precisely, the analysis revealed the following distribution:
0.25 wt % of platinum in the honeycomb elements, namely 4.0 g;
0.07 wt % of platinum in the coating cement, namely 0.15 g; and
0.10 wt % of platinum in the joint cement, namely 0.15 g.

It is thus shown that by incorporating a small amount of a hydrophobic material into the cement before the step of impregnating in the aqueous catalyst solution, it is possible to achieve, in the end, a substantial saving in Pt. More exactly, the comparison of the results obtained according to examples 1 and 2 shows that the application of the process according to the invention makes it possible to save a not insignificant amount of catalyst and in particular of precious metal (0.2 g per filter), thus generating a substantial saving in the overall cost of the process for depositing catalyst on the structure.

### EXAMPLE 3

A catalytic filter was manufactured by repeating the same steps as those from example 1. Masks were then applied to the parts of the filter on which it was not desired to deposit the hydrophobic agent, that is to say the parts other than the apparent cement joints between elements and the coating cement of the filter. The masks were carefully cut out and positioned manually, due to irregularities of the front and rear surfaces of the filter, inherent to the process of assembling the elements. The thus masked filter was then positioned in a desiccator on a support plate. Around 0.5 ml of perfluorodecyltrichlorosilane per filter was deposited in the bottom of the desiccator. The reactor was then sealed and heated to a temperature of 100° C. with a residual pressure of around 0.1 mbar (1 bar=0.1 MPa). This procedure made it possible to vaporize the silane which was then deposited on the unmasked parts. After removing the masks, this crude structure was then submerged in a bath of an aqueous solution as in example 1.

The chemical analysis showed a total Pt concentration of 48 g/ft³, namely 4.2 g distributed over the various parts of the filter.

More precisely, the analysis revealed the following distribution:
0.25 wt % of platinum in the honeycomb elements, namely 4.0 g;
0.07 wt % of platinum in the coating cement, namely 0.1 g; and
0.04 wt % of platinum in the joint cement, namely 0.1 g.

The comparison of the results obtained according to examples 1 and 3 shows that the application of the process according to the invention may make it possible to save a not insignificant amount of catalyst and in particular of precious metal (0.3 g per filter), thus generating a substantial saving in the overall cost of the process for depositing catalyst on the structure.

It is clearly understood that the present invention does not amount to this simple embodiment and that any known means of acting on the hydrophobic or oleophobic character of the joint/coating cements should be considered as being included within the scope of the present invention.

1: A structure that can be used, after deposition of a catalyst, for filtering a gas loaded with soot particles and pollutants in the gas phase and comprising:
a central part comprising a plurality of filtering elements as a honeycomb connected together by a joint cement, said element or elements comprising a set of adjacent ducts or channels with axes parallel with one another separated by porous walls, which ducts are stopped by plugs at one or other of their ends to delimit inlet chambers opening on a gas intake face and outlet chambers opening on a gas discharge face, in such a way that the gas passes through the porous walls; and
a peripheral part made up of a coating cement protecting said elements, said structure being characterized in that the coating cement, preferably the joint cement and optionally the cement forming the plugs, comprise, at least at the surface and preferably in the porosity, a hydrophobic or oleophobic material.

2: The structure as claimed in claim 1, composed of a filtering block combining several honeycomb monolithic filtering elements, said elements being assembled and bonded by a joint cement comprising a hydrophobic or oleophobic material.

3: The structure as claimed in claim 1, in which said elements, the coating cement and preferably the joint cement and/or the cement forming the plugs are based on one and the same ceramic material, preferably based on silicon carbide SiC.

4: A process for obtaining a filter for filtering a gas loaded with soot particles and pollutants in the gas phase such as carbon monoxide CO, nitrogen oxides NOₓ, sulfur oxides SOₓ, hydrocarbons HC, said process comprising the steps of:
manufacturing a first structure as claimed in claim 1, in which the coating cement and the joint cement and the cement forming the plugs comprise a hydrophobic material; and
impregnating said structure with a solution containing a catalyst precursor or the catalyst dissolved in a polar solvent, or a suspension of catalyst particles in a polar solvent.

5: The process as claimed in claim 4, in which the hydrophobic material is in the form of a powder of a material included in the group composed of carbon graphite, CaF₂, or other hydrophobic mineral powders containing the element fluorine.

6: The process as claimed in claim 4, in which the hydrophobic material comprises at least one organic or organometallic compound chosen from the metal salts of C₁₂-C₂₀ fatty acids selected from alkali metal or alkaline-earth metal stearates or oleates, silicones, silanes, siloxanes, siliconates, organofluoro compounds having a low surface tension including PTFE powders, acrylic and vinyl resins, or paraffin oils.

7: A process for obtaining a filter for filtering a gas loaded with soot particles and pollutants in the gas phase such as carbon monoxide CO, nitrogen oxides NOₓ, sulfur oxides SOₓ, hydrocarbons HC, said process comprising the steps of:
manufacturing a first structure as claimed in claim 1, in which the coating cement and the joint cement and the cement forming the plugs comprise an oleophobic material; and
impregnating said structure with a solution containing a catalyst precursor or the catalyst dissolved in a hydrophobic solvent selected from a hydrocarbon or an oil, or a suspension of catalyst particles in a solvent selected from a hydrocarbon or an oil.

8: The process as claimed in claim 7, in which the oleophobic material is included in the group composed of silanes, siloxanes, siliconates and organofluoro compounds having a low surface tension.

9: The process as claimed in claim 4, in which the hydrophobe or oleophobe is incorporated into the formulation of the coating and/or joint cement before the step of coating and assembling the structure.

10: The process as claimed in claim 4, in which the hydrophobe or oleophobe is incorporated after the step of coating and assembling the structure by a liquid or gaseous route by deposition onto the structure in liquid form or in gaseous form.

11. The process as claimed in claim 4, in which said impregnation may be carried out by pumping the solution through the structure, by application of a vacuum or an underpressure or under the pressure of the liquid comprising the impregnation solution over at least one end of the structure or by a combination of these various techniques.

12: A catalytic filter able to be obtained by the process as claimed in claim 7, being characterized by the presence of a hydrophobic or oleophobic material at the surface and in the porosity of said coating and/or joint cement, and also by the presence of a minimal amount of catalyst on said cement.
